(19) United States
(12) Patent Application Publication
(10) Pub. No.: US 2011/0217521 A1
(43) Pub. Date: Sep. 8, 2011

(54) GLASS ROLL, AND METHOD OF MANUFACTURING GLASS ROLL

(76) Inventors: Yasuo TERANISHI, Otsu-shi (JP); Yoshinori Hasegawa, Otsu-shi (JP); Koichi Mori, Otsu-shi (JP); Hiroki Mori, Otsu-shi (JP)

(21) Appl. No.: 13/038,747

(22) Filed: Mar. 2, 2011

(30) Foreign Application Priority Data
Mar. 3, 2010 (JP) 2010-046111

(51) Int. Cl. B32B 17/06; B32B 3/02; C03B 17/06

(52) U.S. Cl. 428/189; 428/426; 428/337; 428/192; 65/94

(57) ABSTRACT

To manufacture a roll body (glass roll) of the glass film, which is subjected to a tension application, and is free from looseness, without adversely affecting the formation of the glass film and causing a problem such as cracks, provided is a method of manufacturing a glass roll (1), including: forming a glass film (2) by a downdraw method; and winding the formed glass film (2) into a roll while superposing the glass film (2) on a protective sheet (3), in which the glass film (2) and the protective sheet (3) are wound while higher tension in a winding direction is applied to the protective sheet (3) than to the glass film.

### TECHNICAL FIELD

The present invention relates to a glass film used for a glass substrate of a flat panel display such as a liquid crystal display or an organic light-emitting diode (OLED) display, for a glass substrate of a device such as a solar cell, a lithium ion battery, a digital signage, a touch panel, or electronic paper, for cover glass of a device such as an OLED lighting, and for a drug package. The present invention also relates to a method of manufacturing the glass roll.

### BACKGROUND ART

In view of space saving, in recent years, there are widely used flat panel displays, such as a liquid crystal display, a plasma display, an OLED display, and a field emission display, in place of a cathode ray tube (CRT) display that has been conventionally and widely used. Such flat panel displays are required to be further thinned. In particular, the OLED display is required to allow easy carrying by being folded or wound, and to allow use not only on a flat surface but also on a curved surface. Further, it is not limited the display required to allow the use not only on a flat surface but also on a curved surface. For example, it is also required to form a solar cell or an OLED lighting on a surface of a product having a curved surface, such as a surface of a vehicle body of an automobile or a roof, a pillar, or an outer wall of a building. Therefore, various glass plates including the flat panel display are required to be further thinned for satisfying a demand for flexibility high enough to deal with a curved surface. As disclosed, for example, in Patent Literature 1, a film-like sheet glass having a thickness of 200 μm or less has been developed.

Meanwhile, in view of ensuring flexibility, a resin film may be used in place of a glass plate. However, there is a problem in that the resin film is inferior to the glass plate in gas barrier property. In a case of the OLED display, a light-emitting body to be used is deteriorated due to contact with gas, such as oxygen or water vapor, and hence the resin film inferior in barrier property cannot be used in place of the glass plate. Further, for the same reason, also in a field other than the OLED display, the resin film cannot be used in place of the glass plate in many cases. Therefore, also in view of ensuring the barrier property described above, thinning of the glass plate takes on increasing importance in actual use.

A glass substrate manufactured by a glass manufacturer is transported to an electronic device manufacturer, and a glass film is incorporated as a component such as a substrate of an electronic device. Therefore, the above-mentioned glass film needs to be packaged so as not to break during transportation to the electronic device manufacturer.

As a package form for a glass film, for example, Patent Literature 2 discloses a new package form in which a glass film, which is formed by a downdraw method, is wound into a roll, after changing its drawing direction to a horizontal direction and then cutting its end edge portion. This package form is made focusing on flexibility of the glass film, and may be effective as the package form for a glass film.

### CITATION LIST

### Patent Literature

Patent Literature 1: JP 2008-133174 A
Patent Literature 2: JP 2000-335928 A

### SUMMARY OF INVENTION

### Problem to be Solved by the Invention

By the way, in a case of winding a long sheet into a roll, in general, winding is performed while applying tension in a winding direction (hereinafter, simply referred to as tension) to the sheet. When winding is performed without applying the tension to the sheet, wrinkles may occur on the sheet, or the roll is loosened. Thus, a phenomenon in which quality of the sheet is deteriorated or the sheet that is wound into a roll slips in a direction of a roll shaft (roll core) to be formed into a telescopic shape, that is, so-called winding slippage occurs. In particular, in a case of winding a long glass film (hereinafter, simply referred to as glass film) into a roll, when winding is performed without applying the tension, though wrinkles occur on the resin film, glass is a brittle material, and hence the glass film easily breaks. Further, even if the glass film does not break but the roll is loosened, the surface of the glass film is rubbed due to the above-mentioned winding slippage to thereby be flawed, and hence there is an intrinsic risk in that the glass film may break in a post-step when using the glass film in the post-step. Therefore, in the case of winding the glass film into a roll, it is particularly necessary to perform winding while applying the tension.

However, on the glass film described in Patent Literature 2, winding is performed after drawing the glass film through the bending zone after forming, and then changing its course into a horizontal one, with the result that the glass film is continuous from a point just after forming of the glass film to a winding point. In the method of manufacturing a glass film, when winding is performed while applying the tension to the glass film, there is a fear in that the curvature may be changed in the bending zone due to a tensile force at the time of winding, which gives adverse effects, such as occurrence of warpage and waviness, and a change in plate thickness, on forming of the glass film. Further, there may be adopted a method of applying the tension to the glass film using a tension roller or the like that is used for the resin film. However, in this case, the surface of the glass film is held in pressure contact with the tension roller or the like, and hence invisible small flaws may occur on the surface of the glass film. Further, when tensile stress generated by the tension and the like acts on the small flaws, the stress is concentrated on ends of the small flaws. Consequently, the small flaws are expanded, resulting in breakage of the glass film. In addition, in a case where the tension at the time of winding is excessively increased, the tension may affect directly the glass film just after its forming.

The present invention has been made in order to solve the conventional technical problems, and has a technical object to manufacture a roll body (glass roll) of the glass film, which is subjected to a tension application, and is free from looseness, without adversely affecting the formation of the glass film and causing a problem such as cracks.

### Means for Solving the Problem

The method of manufacturing a glass roll according to claim 1 includes: forming a glass film by a downdraw method; and winding the formed glass film into a roll while superposing the glass film on a protective sheet, in which the glass film and the protective sheet are wound while higher tension in a winding direction is applied to the protective sheet than to the glass film.

According to the invention of claim 2, in the method of manufacturing a glass roll according to claim 1, a selvage portion formed at each end portion in a width direction of the glass film is cut with a laser by the time the glass film is wound into a roll.

According to the invention of claim 3, in the method of manufacturing a glass roll according to claim 1 or 2, the glass film and the protective sheet are wound while the protective sheet is superposed on an outer peripheral side of the glass film so that the protective sheet is kept to form an outermost layer.

According to the invention of claim 4, in the method of manufacturing a glass roll according to any one of claims 1 to 3, the downdraw method includes an overflow downdraw method.

The invention according to claim 5 is a glass roll, which is obtained by winding a glass film formed by a downdraw method into a roll while superposing the glass film on a protective sheet, in which higher tension in a winding direction is applied to the protective sheet than to the glass film.

According to the invention of claim 6, in the glass roll according to claim 5, the glass film has a thickness of 1 μm or more and 200 μm or less.

According to the invention of claim 7, in the glass roll according to claim 5 or 6, each end surface in a width direction of the glass film has an arithmetic average roughness Ra of 0.1 μm or less.

According to the invention of claim 8, in the glass roll according to any one of claims 5 to 7, the protective sheet extends beyond both sides in the width direction of the glass film.

### Advantageous Effects of Invention

According to the invention of claim 1, provided is a method of manufacturing a glass roll, including: forming a glass film by a downdraw method; and winding the formed glass film into a roll while superposing the glass film on a protective sheet, in which the glass film and the protective sheet are wound while higher tension in a winding direction is applied to the protective sheet than to the glass film. Thus, high tension in the winding direction is not applied to the glass film, and hence it is possible to produce the glass roll free from loose winding owing to relatively high tension in the winding direction applied to the protective sheet. Because the tension in the winding direction is not applied to the glass film when winding the glass film or the tension is low, it is possible to prevent a change in curvature of a curved region during feed of the glass film along with its winding, and forming of the glass film is stabilized, with result that the glass film free from warpage, waviness, and a change in film thickness can be wound. Further, small flaws do not occur on the surface of the glass film.

According to the invention of claim 2, a selvage portion formed at each end portion in a width direction of the glass film is cut with a laser by the time the glass film is wound into a roll. Thus, without performing post-processing such as polishing, it is possible to easily impart moderate smoothness to a cut surface constituting each end surface in the width direction of the glass film. Relatively high tension in the winding direction is applied to the protective sheet, and hence the end surface of the glass film and the protective sheet are easily held in contact with each other. However, even in the case of contact, owing to the smoothed end surface of the glass film, the end surface does not bite into the protective sheet, and hence it is possible to satisfactorily maintain separability between the glass film and the protective sheet. Further, when winding the glass film into a roll, chips resulting from small flaws are less likely to occur on the each end surface of the glass film. Thus, it is possible to reduce glass powder, which is generated due to the chips on the end surface of the glass film, and hence there is a great advantage in ensuring cleanness of the front and back surfaces of the glass film. The cutting by the laser described herein includes: laser splitting utilizing thermal stress resulting from heating by the laser and cooling by a refrigerant; and laser fusing of fusing and cutting glass by heating by the laser.

According to the invention of claim 3, the glass film and the protective sheet are wound so that the protective sheet is kept to form an outermost layer. Thus, by applying relatively high tension in the winding direction to the protective sheet, the glass film can be easily fastened. Consequently, it is possible to manufacture the glass roll free from looseness.

According to the invention of claim 4, the downdraw method includes an overflow downdraw method. Thus, it is possible to form the glass film excellent in surface smoothness without performing additional processing after the forming, and to manufacture the glass roll excellent in surface accuracy.

According to the invention of claim 5, provided is a glass roll in which higher tension in a winding direction is applied to the protective sheet than to the glass film. Thus, it is possible to provide the glass roll obtained by tightly winding the glass film free from warpage, waviness, and a change in film thickness.

According to the invention of claim 6, the glass film has a thickness of 1 μm or more and 200 μm or less. Thus, it is possible to impart appropriate flexibility to the glass film. Accordingly, it is possible to alleviate overstress applied to the glass film when winding the glass film, and to prevent the glass film from breaking.

According to the invention of claim 7, each end surface in a width direction of the glass film has an arithmetic average roughness Ra of 0.1 μm or less. Thus, it is possible to impart appropriate smoothness to the each end surface in the width direction of the glass film. Relatively high tension in the winding direction is applied to the protective sheet, and hence the end surface of the glass film and the protective sheet are easily held in contact with each other. However, even in the case of contact, owing to the smoothed end surface of the glass film, the end surface does not bite into the protective sheet, and hence it is possible to satisfactorily maintain separability between the glass film and the protective sheet.

According to the invention of claim 8, the protective sheet extends beyond both sides in the width direction of the glass film. Thus, it is possible to protect the each end surface in the width direction of the glass film with the protective sheet. Further, each end in the width direction of the glass film is covered with the protective sheet, and hence it is also possible to prevent intrusion of foreign matters from an outside.

### BRIEF DESCRIPTION OF DRAWINGS

FIG. 1 A diagram illustrating a method of manufacturing a glass roll according to the present invention.

FIG. 2 An explanatory diagram illustrating a method of applying heat of laser irradiation to a glass film, thereby splitting the glass film using thermal stress generated by the application.

### MODE FOR CARRYING OUT THE INVENTION

Hereinafter, a glass roll according to the present invention and a preferred embodiment of a method of manufacturing the same are described with reference to the drawings.

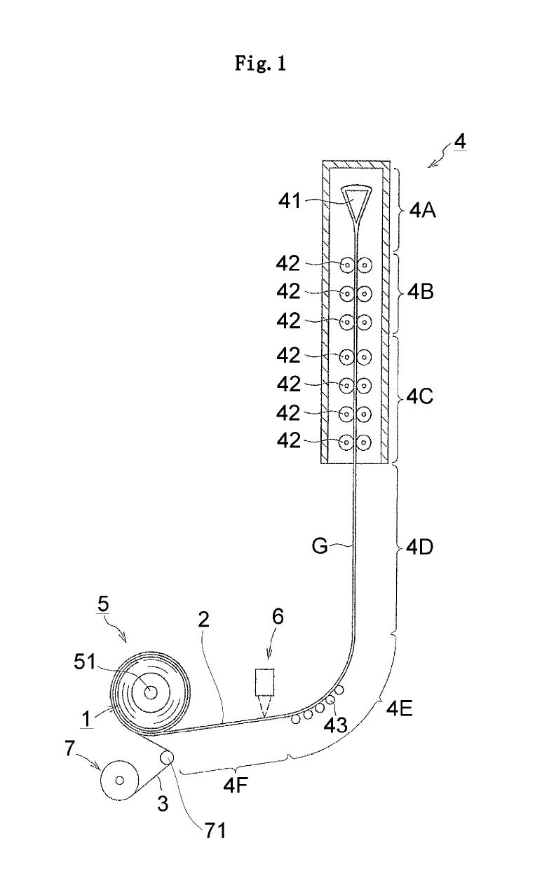

As illustrated in FIG. 1, a glass roll (1) according to the present invention is produced in such a manner that a glass film (2) is formed by a downdraw method and a protective sheet (3) is superposed on an outer peripheral side of the formed glass film (2), and then the glass film (2) and the protective sheet (3) are wound into a roll so that higher tension in a winding direction is applied to the protective sheet (3) than to the glass film (2).

Specifically, a trough (41) having a wedge-shaped outer surface in cross-section is disposed inside a forming apparatus (4), and glass (molten glass) melted in a melting furnace (not shown) is supplied into the trough (41). As a result, the molten glass overflows from a top of the trough (41). Then, the overflowing molten glass flows over both side surfaces of the trough (41) having a wedge-shaped cross-section, and interflows at a lower end thereof. Thus, forming of a glass film ribbon (G) from the molten glass is started. In this way, the glass film ribbon (G), which is formed in a forming region (4A) situated in an uppermost part of the forming apparatus (4), flows downward as it is to reach an annealing region (4B) situated below the forming region (4A). Then, in the annealing region (4B), the residual strain is removed (annealing treatment is performed) while the glass film ribbon (G) is annealed. A cooling region (4C) is provided on a further downstream side of (below) the annealing region (4B), and the annealed glass film ribbon (G) is sufficiently cooled to a temperature of about room temperature. In the annealing region (4B) and the cooling region (4C), a plurality of rollers (42) for guiding the glass film ribbon (G) downward are arranged. Note that, in this embodiment, the rollers (42) disposed in an uppermost part of annealing region (4B) of the forming apparatus (4) function as cooling rollers for cooling the glass film ribbon (G), and also function as driving rollers for imparting a downward drawing force to the glass film ribbon (G). The other rollers (42) function as idle rollers, tension rollers, and the like for drawing the glass film ribbon (G) while guiding the glass film ribbon (G) downward.

While changing an advancing direction from a vertical direction to a horizontal direction, the glass film ribbon (G) that has passed the cooling region (4C) is drawn toward a winding apparatus (5) arranged on a most downstream side of an apparatus for manufacturing the glass film (2). Specifically, below the cooling region (4C), there is continuously provided a vertical drawing region (4D) in which the glass film ribbon (G) is continuously drawn vertically downward. Below the vertical drawing region (4D), there is continuously provided a curved region (4E) in which the glass film ribbon (G) is curved so that the direction of drawing the glass film ribbon is changed from the vertical direction to substantially the horizontal direction. In this embodiment, as illustrated in FIG. 1, there are provided a plurality of curving assist rollers (43) for curving the glass film ribbon (G) at a predetermined radius of curvature in the curved region (4E). Owing to operation of the plurality of curving assist rollers (43), the glass film ribbon (G) is fed toward a horizontal drawing region (4F) described below. In addition, on the downstream side of the curved region (4E) (left side of the curved region (4E) in FIG. 1), the horizontal drawing region (4F) is continuously provided, in which the glass film ribbon (G) that has passed the curved region (4E) is drawn to substantially the horizontal direction.

Further, in the horizontal drawing region (4F), a longitudinal-direction cutting apparatus (6) capable of cutting the glass film ribbon (G) along its longitudinal direction is disposed, and can continuously cut, along the longitudinal direction, each end portion in a width direction of the glass film ribbon (G) that has passed the curved region (4E) to reach the horizontal drawing region (4F).

Here, as the longitudinal-direction cutting apparatus (6), there can be used an apparatus which forms a scribe line using a diamond cutter, and cuts a selvage portion along the scribe line by bend breaking and separating the selvage portion. However, in view of improvement of strength of a cut surface, it is preferred to use a laser splitting apparatus including, for example, locally heating means, cooling means, a support member for supporting a back surface of the glass film ribbon around a line to be cut, and crack forming means for forming an initial crack in the line to be cut. With this, without performing post-processing such as polishing, it is possible to easily impart moderate smoothness to the cut surface constituting each end surface in the width direction of the glass film (2). The end surface of the glass film (2) is smooth, and hence the end surface of the glass film (2) does not bite into the protective sheet (3), with the result that separability between the glass film (2) and the protective sheet (3) can be satisfactorily maintained. Further, when winding the glass film (2) into a roll, chips resulting from small flaws are less likely to occur on each end surface of the glass film (2).

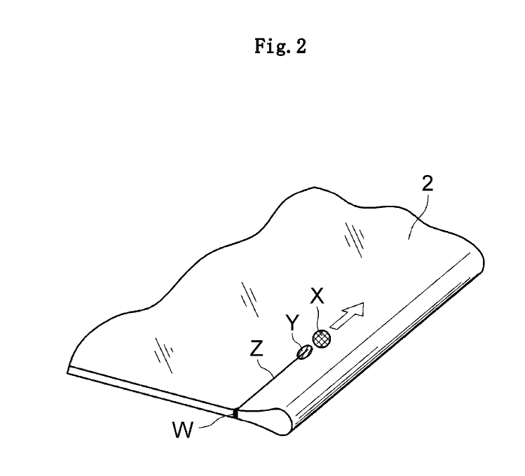

In laser splitting, as illustrated in FIG. 2, an initial crack (W) is formed in an end portion on a downstream side of the glass film (2), and, after scanning the glass film along the longitudinal direction of the glass film (2) with a heating point (X) of laser irradiation, the heated portion is cooled while scanning the glass film with a cooling point (Y) of a refrigerant, to thereby form a split line (Z) while causing the initial crack (W) to develop due to the thermal stress generated by heating and cooling. Here, the split line (Z) is formed continuously from a front surface up to a back surface of the glass film (2). Therefore, at the point in time when the initial crack (W) is caused to develop to thereby form the split line (Z), there is cut off the selvage portion corresponding to the portion in which the split line (Z) is formed. Note that, under a state in which the heating point (X) of the laser and the cooling point (Y) of the refrigerant are fixed, scanning with the heating point (X) of the laser and the cooling point (Y) of the refrigerant is performed by sequentially conveying the glass film (2) to a downstream side in a conveying direction (left direction in the example illustrated in FIG. 1).

As described above, after cutting each end portion in the width direction of the glass film ribbon (G), the glass film (2) from which its each end portion in the width direction is eliminated is wound into a roll around a roll core (51) of the winding apparatus (5). At this time, as illustrated in FIG. 1, a protective sheet supplying apparatus (7) is disposed in the vicinity of the winding apparatus (5), and the protective sheet (3) supplied from the protective sheet supplying apparatus (7) is wound together with the glass film (2) into a roll around the roll core (51) of the winding apparatus (5). As illustrated in FIG. 1, the protective sheet supplying apparatus (7) includes a tension applying roller (71). The glass roll (1) is produced by winding the glass film (2) and the protective sheet (3) under a state in which higher tension in the winding direction is applied to the protective sheet (3) than to the glass film (2). Alternatively, the glass roll (1) may be produced by, without using the tension applying roller (71), feeding the protective sheet (3) from the protective sheet supplying apparatus (7) against a winding force for the winding apparatus (5) to wind the glass film (2) and the protective sheet (3), thereby winding the glass film (2) and the protective sheet (3) under a state in which higher tension in the winding direction is applied to the protective sheet (3) than to the glass film (2). Thus, high tension in the winding direction is not applied to the glass film (2), whereas relatively high tension in the winding direction is applied to the protective sheet (3). As a result, it is possible to produce the glass roll (1) free from loose winding. The tension in the winding direction is not actively (intentionally) applied to the glass film (2) when winding the glass film (2). Thus, a change in curvature of the curved region (4E) can be prevented, and forming of the glass film ribbon (G) is stabilized, with the result that the glass film (2) free from warpage, waviness, and a change in film thickness can be wound.

The tension applied to the protective sheet (3) is preferably 0.01 to 10 GPa. When the tension is lower than 0.01 GPa, there is a fear in that a repulsive force of the glass film (2) becomes stronger than the tension, and hence it is difficult to produce the glass roll (1) free from looseness. When the tension exceeds 10 GPa, there is a fear in that the protective sheet (3) may break depending on its material. The tension applied to the protective sheet (3) is more preferably 0.05 to 5 GPa, and most preferably 0.1 to 2.5 GPa.

It is preferred that lower tension be applied to the glass film (2), and it is preferred that no tension be substantially applied thereto. By suppressing the tension applied to the glass film (2), it is possible to increase forming accuracy of the glass film ribbon (G).

Then, at the point in time when a roll diameter (thickness dimension) of the glass roll (1) obtained by being wound reaches a predetermined dimension, the glass film (2) is cut in the width direction by a width-direction cutting apparatus (not shown). In this case, the width-direction cutting apparatus may be situated further on a downstream side of a drawing path of the glass film ribbon (G) than the longitudinal-direction cutting apparatus (6), or in contrast to this, the longitudinal-direction cutting apparatus (6) may be situated further on the downstream side thereof than the width-direction cutting apparatus. Through the above-mentioned steps, the glass roll (1) as a finished product is obtained.

In the present invention, it is preferred that the glass film (2) be formed by an overflow downdraw method. The reason is as follows. The overflow downdraw method is a forming method in which both surfaces of a glass plate are not held in contact with a forming member during forming, and hence flaws are less likely to occur on both the surfaces (translucent surfaces) of the obtained glass plate, and high surface quality can be obtained without polishing.

Further, the glass roll (1) according to the present invention is obtained by winding the glass film (2), which is formed by the downdraw method, into a roll while superposing the glass film on the protective sheet (3). The protective sheet (3) is characterized by being subjected to application of higher tension in the winding direction than the glass film (2).

It is preferred to use a silicate glass as the glass film (2), preferably, it is preferred to use a silica glass or a borosilicate glass, it is most preferred to use a non-alkali glass. When the glass film (2) contains an alkali component, cationic elimination is generated on the surface, and a phenomenon, so-called white weathering, occurs so that the glass film is structurally weathered. In this case, when the glass film (2) is used while being curved, there is a fear in that the glass film is prone to break from a portion that is weathered over time. Note that, herein, the non-alkali glass includes glass that does not substantially contain an alkali metal oxide, specifically, glass containing an alkali metal oxide of 1000 ppm or less. In the present invention, the content of the alkali component is preferably of 500 ppm or less of alkali metal oxide, more preferably of 300 ppm or less of alkali metal oxide. For example, preferred is OA-10G, manufactured by Nippon Electric Glass Co., Ltd.

The glass film (2) is allowed to be wound, and hence is particularly suitable for a long product. That is, a length (long side) of the glass film (2) is preferably 3 times or more, more preferably 5 times or more, and still more preferably 10 times or more longer than a width (short side) of the glass film. Even when the glass film is such a long product, the glass film allows compact package, which is suitable in transportation. The width of the glass film (2) is 12.5 mm or more, and is selected as needed depending on a size of a substrate of a device to be used, such as a small-screen display for a mobile phone or a large-screen display. However, the width of the glass film is preferably 100 mm or more, more preferably 300 mm or more, and still more preferably 500 mm or more.

A thickness of the glass film (2) is more preferably 1 μm to 200 μm, and most preferably 10 μm to 100 μm. The reason is as follows. When the glass film (2) has the thickness described above, it is possible to impart appropriate flexibility to the glass film (2), to alleviate overstress applied to the glass film (2) when winding the glass film (2), and to prevent the glass film (2) from breaking. In a case where the thickness of the glass film is less than 1 μm, strength of the glass film (2) is unsatisfactory. In a case where the thickness of the glass film exceeds 200 μm, there is increased a risk in that the glass film may break due to tensile stress when the glass film (2) is wound into a roll with a small diameter. Therefore, both cases are not preferred.

An arithmetic average roughness Ra of each end surface in the width direction of the glass film (2) is preferably 0.1 μm or less, and more preferably 0.05 μm or less. This is because it is possible to impart appropriate smoothness to the each end surface in the width direction of the glass film (2). Therefore, in this case, when the glass film (2) is wound into a roll, small flaws are less likely to occur on the each end surface of the glass film (2), and hence it is possible to wind the glass film (2) without any trouble. Further, it is possible to reduce glass powder, which is generated due to chips and the like resulting from the small flaws on the end surface of the glass film (2), and hence there is an advantage in ensuring cleanness of the front and back surfaces of the glass film (2). In addition, even in a case where the end surface of the glass film (2) is held in contact with the protective sheet (3), the end surface of the glass film (2) does not bite into the protective sheet (3), and the glass film and the protective sheet can be separated from each other easily. Consequently, prevention of breakage of the glass film (2) is achieved.

When winding the glass film (2), the protective sheet (3) prevents occurrence of the flaws, which is caused by contact of one part of the glass film (2) with another, and the protective sheet is used for absorbing external pressure when the external pressure is applied to the glass roll (1). Therefore, it is preferred that a thickness of the protective sheet (3) be from 10 μm to 2000 μm. In a case where the thickness is less than 10 μm, cushioning performance of the protective sheet is unsatisfactory. In a case where the thickness exceeds 2000 μm, there is extremely increased a roll outer diameter of the glass roll formed after winding the glass film (2). Therefore, both the cases are not preferred.

When producing the glass roll (1) according to the present invention, a temperature of the glass film (2) may exceed 50° C. Thus, it is preferred that the protective sheet (3) be not transformed, for example, softened at a temperature of about 100° C.

It is preferred that the protective sheet (3) be wider than the glass film (2) in the width direction. That is, it is preferred that, in a state of the glass roll (1), the protective sheet (3) extend beyond both sides in the width direction of the glass film (2). The reason is as follows. With this configuration, each end surface in the width direction of the glass film (2) is protected with the protective sheet (3), and hence it is possible to prevent small flaws and chips due to impact or the like from occurring on the each end surface in the width direction of the glass film (2).

As the protective sheet (3), there can be used an ionomer film, a polyethylene film, a polypropylene film, a polyvinyl chloride film, a polyvinylidene chloride film, a polyvinyl alcohol film, a polypropylene film, a polyester film, a polycarbonate film, a polystyrene film, a polyacrylonitrile film, an ethylene vinyl acetate copolymer film, an ethylene-vinyl alcohol copolymer film, an ethylene-methacrylate copolymer film, a polyamide resin film (nylon film), a polyimide resin film, a buffer made of a resin such as cellophane, inserting paper, and a nonwoven fabric. It is preferred that a polyethylene foam sheet be used as the protective sheet (3), because the polyethylene foam sheet can absorb impact, and has high strength with respect to tensile stress. Meanwhile, when silica or the like is dispersed in those resin films so that a degree of slip on the glass film (2) is increased, the slip can preferably absorb a difference of lengths to be wound, which results from a slight difference of diameters caused when the glass film (2) and the protective sheet (3) are wound while being superposed on each other.

It is preferred that an elastically deformable material be used for the protective sheet (3). With this, it is possible to produce the glass roll (1) free from looseness while applying appropriate tension in the winding direction to the protective sheet (3). It is preferred that a tensile elastic modulus of the protective sheet (3) be from 1 to 5 GPa.

It is preferred that conductivity be imparted to the protective sheet (3). This is because, when the glass film (2) is taken out of the glass roll (1), peeling electrification is less likely to occur between the glass film (2) and the protective sheet (3) so that the glass film (2) and the protective sheet (3) can be easily peeled off. Specifically, for example, in a case where the protective sheet (3) is made of a resin, it is possible to impart the conductivity by adding a component for imparting the conductivity, such as polyethylene glycol, into the protective sheet (3). In a case where the protective sheet (3) is made of inserting paper, it is possible to impart the conductivity by adding conductive fiber. Further, it is possible to impart the conductivity also by laminating a conductive layer, such as an indium-tin-oxide (ITO) film, on a surface of the protective sheet (3).

### INDUSTRIAL APPLICABILITY

The present invention can be preferably used for a glass substrate used for a flat panel display, such as a liquid crystal display or an OLED display, for a glass substrate used for a device such as a solar cell, and for cover glass for an OLED lighting.

### REFERENCE SIGNS LIST

1 glass roll
2 glass film
3 protective sheet
4 forming apparatus
5 winding apparatus
6 longitudinal-direction cutting apparatus
7 protective sheet supplying apparatus
G glass film ribbon

1. A method of manufacturing a glass roll, comprising:
forming a glass film by a downdraw method; and
winding the formed glass film into a roll while superposing the glass film on a protective sheet,
wherein the glass film and the protective sheet are wound while higher tension in a winding direction is applied to the protective sheet than to the glass film.

2. The method of manufacturing a glass roll according to claim 1, wherein a selvage portion formed at each end portion in a width direction of the glass film is cut with a laser by the time the glass film is wound into a roll.

3. The method of manufacturing a glass roll according to claim 1, wherein the glass film and the protective sheet are wound while the protective sheet is superposed on an outer peripheral side of the glass film so that the protective sheet is kept to form an outermost layer.

4. The method of manufacturing a glass roll according to claim 1, wherein the downdraw method comprises an overflow downdraw method.

5. A glass roll, which is obtained by winding a glass film formed by a downdraw method into a roll while superposing the glass film on a protective sheet,
wherein higher tension in a winding direction is applied to the protective sheet than to the glass film.

6. The glass roll according to claim 5, wherein the glass film has a thickness of 1 μm or more and 200 μm or less.

7. The glass roll according to claim 5, wherein each end surface in a width direction of the glass film has an arithmetic average roughness Ra of 0.1 μm or less.

8. The glass roll according to claim 5, wherein the protective sheet extends beyond both sides in the width direction of the glass film.

9. The method of manufacturing a glass roll according to claim 2, wherein the glass film and the protective sheet are wound while the protective sheet is superposed on an outer peripheral side of the glass film so that the protective sheet is kept to form an outermost layer.

10. The method of manufacturing a glass roll according to claim 2, wherein the downdraw method comprises an overflow downdraw method.

11. The method of manufacturing a glass roll according to claim 3, wherein the downdraw method comprises an overflow downdraw method.

12. The method of manufacturing a glass roll according to claim 9, wherein the downdraw method comprises an overflow downdraw method.

13. The glass roll according to claim 6, wherein each end surface in a width direction of the glass film has an arithmetic average roughness Ra of 0.1 μm or less.

14. The glass roll according to claim 6, wherein the protective sheet extends beyond both sides in the width direction of the glass film.

15. The glass roll according to claim 7, wherein the protective sheet extends beyond both sides in the width direction of the glass film.

15. The glass roll according to claim 13, wherein the protective sheet extends beyond both sides in the width direction of the glass film.
